(19) United States
(12) Patent Application Publication
(10) Pub. No.: US 2012/0268477 A1
(43) Pub. Date: Oct. 25, 2012

(54) INFORMATION PROCESSING APPARATUS THAT CAN BE COMFORTABLY USED BY SPECIFIC USER, METHOD OF CONTROLLING THE INFORMATION PROCESSING APPARATUS, PROGRAM, AND STORAGE MEDIUM

(75) Inventor: Yohei Shogaki, Kawasaki-shi (JP)

(73) Assignee: CANON KABUSHIKI KAISHA, Tokyo (JP)

(21) Appl. No.: 13/394,493

(22) PCT Filed: Feb. 2, 2012
(86) PCT No.: PCT/JP2012/052906

§ 371 Date: Mar. 6, 2012

(30) Foreign Application Priority Data
Feb. 9, 2011 (JP) 2011-025887

(51) Int. Cl. G09G 5/02; G09G 5/00

(52) U.S. Cl. 345/589; 345/619

(57) ABSTRACT

An information processing apparatus which is capable of switching the method of display according to screen forming elements of a screen to be displayed such that the screen can be displayed in accordance with an accessibility-related setting. A controller of the apparatus determines whether or not an accessibility-related setting has been enabled. When it is determined that the accessibility-related setting has been enabled and that screen forming elements of a screen to be displayed on a display section are of a specific type, the controller changes a method of displaying the elements and thereby generates the screen.

### TECHNICAL FIELD

The present invention provides an information processing apparatus, such as a personal computer or a multifunction peripheral, a method of controlling the information processing apparatus, a program, and a storage medium.

### BACKGROUND ART

A known information processing apparatus, such as a personal computer or a multifunction peripheral, displays a still image or a moving image e.g. on a display device or a touch panel to thereby provide information to a user.

However, when such an image is displayed in a color assignment pattern hard e.g. for a special type of user, such as a weak-sighted person or a visually-impaired person, to recognize, it is sometimes difficult for the person to use the information processing apparatus comfortably.

To comply with the demands of such a special type of users, there has been proposed an information processing apparatus in which a display processing section generates screen information for use in displaying a screen with a predetermined color assignment pattern according to switching information from an input section (see e.g. PTL (Patent Literature) 1).

### CITATION LIST

### Patent Literature

PTL 1: Japanese Patent Laid-Open Publication No. 2005-182461

### SUMMARY OF INVENTION

### Technical Problem

However, even if the color assignment pattern is changed, a user of the above-mentioned special type may not be able to perform comfortable operation depending displayed contents.

For example, in a case where the displayed contents are of an actually shot image or the like which is weaker in contrast than illustrations, even if the color assignment pattern is changed, the special user can have difficulty in recognizing the contents. Further, in a case where the displayed contents are of a moving image or the like which contains a larger amount of information per time period than a still image, it is difficult to improve the ease of recognition even if the color assignment pattern is changed.

The present invention provides an information processing apparatus which is capable of switching the method of display according to screen forming elements of a screen to be displayed such that the screen can be displayed in accordance with an accessibility-related setting, to thereby provide a screen that can be comfortably and easily used by the special type of user, a method of controlling the information processing apparatus, a program, and a storage medium.

### Solution to Problem

Accordingly, in a first aspect of the present invention, there is provided an information processing apparatus comprising a determination unit configured to determine whether or not an accessibility-related setting has been enabled, and a generation unit configured to be operable when the determination unit determines that the accessibility-related setting has been enabled and when screen forming elements forming a screen to be displayed on a display section are of a specific type, to change a method of displaying the screen forming elements and thereby generate the screen.

Accordingly, in a second aspect of the present invention, there is provided an information processing apparatus, comprising a determination unit configured to determine whether or not an accessibility-related setting has been enabled, and a generation unit configured to be operable when the determination unit determines that the accessibility-related setting has been enabled, and when screen forming elements forming a screen to be displayed on a display section are of a specific type, and further the screen to be displayed contains a specific type of contents for display, to change a method of displaying the screen forming elements and thereby generate the screen.

Accordingly, in a third aspect of the present invention, there is provided an information processing apparatus including a console section capable of displaying a display screen, comprising a setting unit configured to set whether or not to reverse display colors of the display screen, and a control unit configured to be operable when a setting of reversing the display colors of the display screen has been set by the setting unit, to reverse the display colors of the display screen and at the same time display a specific type of screen forming elements to be displayed on the display screen by a different display method from a display method employed in a case where the setting of reversing the display colors of the display screen has not been set by the setting unit.

Accordingly, in a fourth aspect of the present invention, there is provided a method of controlling an information processing apparatus, comprising determining whether or not an accessibility-related setting has been enabled, and changing, when it is determined by the determining that the accessibility-related setting has been enabled and when screen forming elements forming a screen to be displayed on a display section are of a specific type, a method of displaying the screen forming elements and thereby generating the screen.

Accordingly, in a fifth aspect of the present invention, there is provided a method of controlling an information processing apparatus including a console section capable of displaying a display screen, comprising setting whether or not to reverse display colors of the display screen, and reversing, when a setting of reversing the display colors of the display screen has been set by the setting, the display colors of the display screen, and at the same time displaying a specific type of screen forming elements to be displayed on the display screen by a different display method from a display method employed in a case where the setting of reversing the display colors of the display screen has not been set by the setting.

Accordingly, in a sixth aspect of the present invention, there is provided a non-transitory computer-readable storage medium storing a computer-executable program for causing a computer to execute a method of controlling an information processing apparatus, wherein the method comprises determining whether or not an accessibility-related setting has been enabled, and changing, when it is determined by the determining that the accessibility-related setting has been enabled and when screen forming elements forming a screen to be displayed on a display section are of a specific type, a method of displaying the screen forming elements and thereby generating the screen.

Accordingly, in a seventh aspect of the present invention, there is provided a non-transitory computer-readable storage medium storing a computer-executable program for causing a computer to execute a method of controlling an information processing apparatus, wherein the method comprises setting whether or not to reverse display colors of the display screen, and reversing, when a setting of reversing the display colors of the display screen has been set by the setting, the display colors of the display screen, and at the same time displaying a specific type of screen forming elements to be displayed on the display screen by a different display method from a display method employed in a case where the setting of reversing the display colors of the display screen has not been set by the setting.

### ADVANTAGEOUS EFFECTS OF INVENTION

According to the present embodiment, when an accessibility-related setting has been set, it is possible to switch the method of display according to the screen forming elements of a screen to be displayed, to thereby enable the special type of user to comfortably use the information processing apparatus.

The features and advantages of the invention will become more apparent from the following detailed description taken in conjunction with the accompanying drawings.

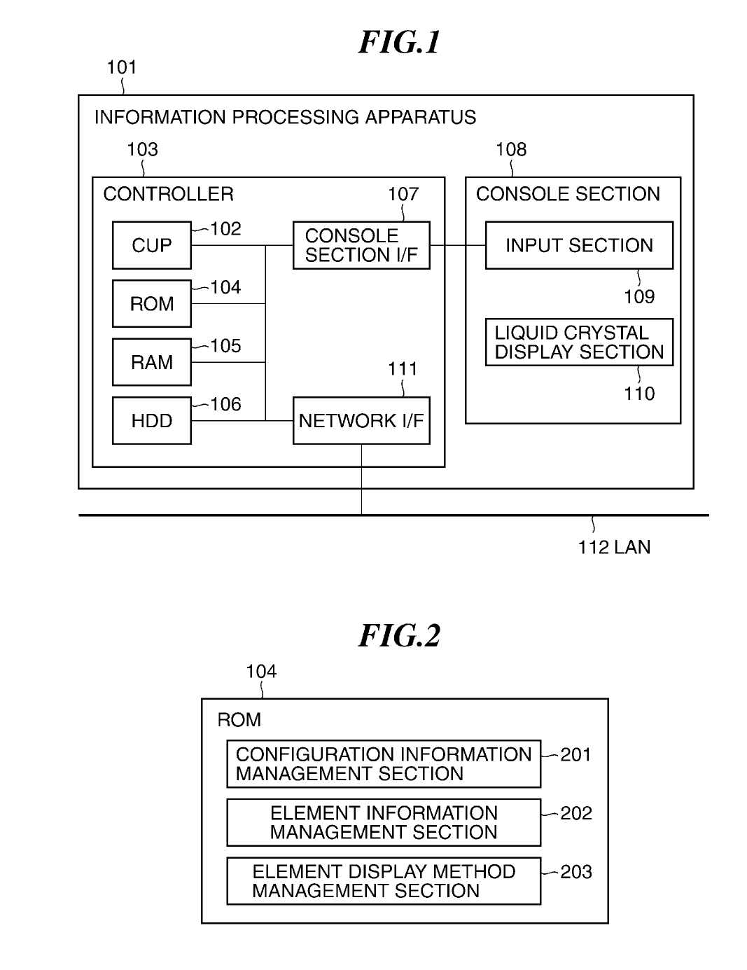

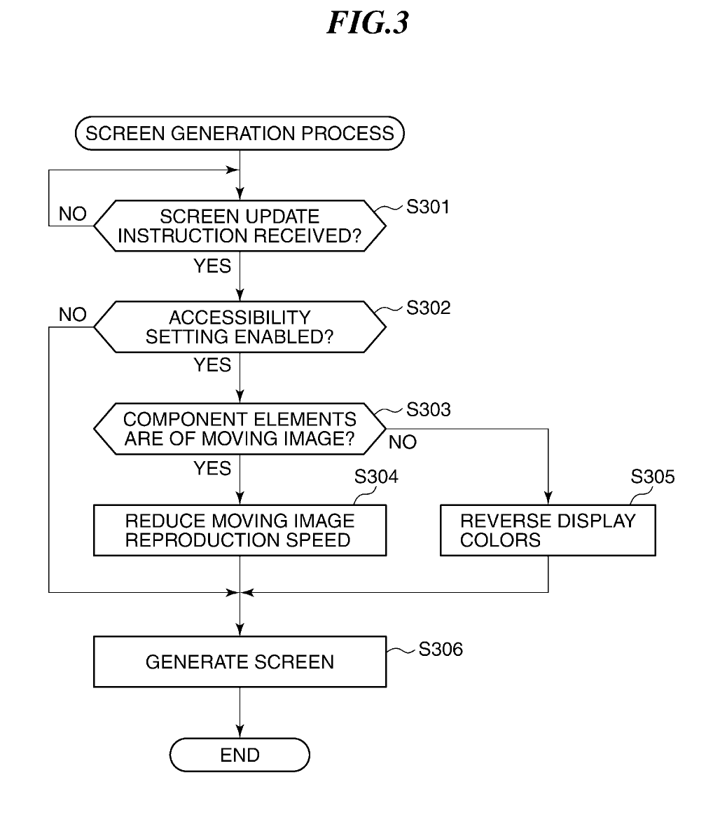

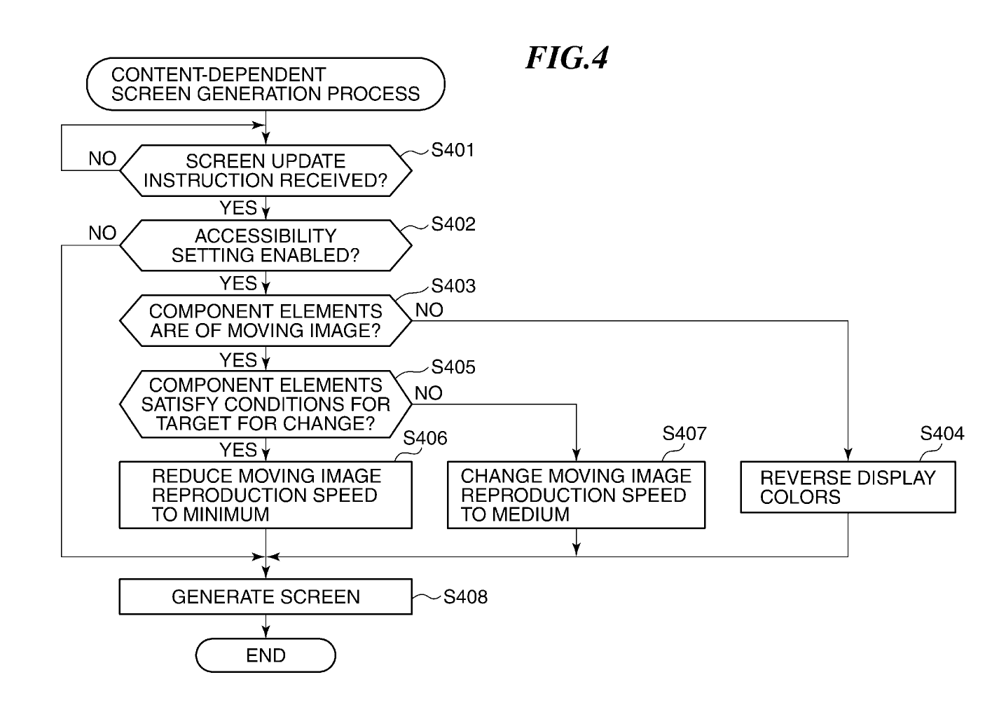

### BRIEF DESCRIPTION OF DRAWINGS

[FIG. 1] A diagram of the whole configuration of an information processing apparatus according to an embodiment of the present invention.

[FIG. 2] A diagram of the software configuration of the information processing system according to the embodiment.

[FIG. 3] A flowchart of a screen generation process executed by the information processing apparatus according to the embodiment.

[FIG. 4] A flowchart of a content-dependent screen generation process executed by the information processing apparatus according to the embodiment.

### DESCRIPTION OF EMBODIMENTS

The present invention will now be described in detail below with reference to the drawings showing embodiments thereof. Note that the present invention is not limited to the embodiments described below, and not all combinations of features described in the embodiments are essential to a solution by the present invention.

Referring to a block diagram in FIG. 1 which shows the whole configuration of an information processing apparatus according to a first embodiment of the present invention, a controller 103 includes a CPU 102, a ROM 104, a RAM 105, and HDD 106, and controls the overall operation of the information processing apparatus 101. The CPU 102 reads out a control program stored in the ROM 104 and performs an associated one of various kinds of control, such as reading control and screen display control.

The RAM 105 is used as a main memory, a work area, and so forth, for the CPU 102. The HDD 106 stores moving image data, various kinds of programs, and various kinds of settings.

A console section interface 107 appearing in FIG. 1 connects between an console section 108 and the controller 103. The console section 108 includes a liquid crystal display section 110 and a plurality of hard keys, and provides user interface for various user operations.

A network interface 111 appearing in FIG. 1 connects the controller 103 (information processing apparatus 101) to a LAN 112. The network interface 111 transmits screen data and information to an external apparatus (e.g. another information processing apparatus) on the LAN 112 or receives various kinds of information from an external apparatus on the LAN 112.

Note that the information processing apparatus is not limited to a PC, but it may be implemented by a computer peripheral apparatus, such as a printer or a multifunction peripheral.

Next, the software configuration of the information processing apparatus 101 will be described with reference to FIG. 2. Functions of the information processing apparatus 101 are realized by the CPU 102 by executing respective software modules (control programs) stored in the ROM 104.

A configuration information management section 201 as a software module, appearing in FIG. 2, manages configuration information on control of the controller 103 of the information processing apparatus 101. The configuration information managed by the configuration information management section 201 includes setting information for switching a method of generating a screen to be displayed on the liquid crystal display section 110 of the console section 108. For example, the configuration information management section 201 manages RGB reversal setting information for use in setting whether or not to change a color assignment pattern on a screen, e.g. whether or not to change a portion in white to black and a portion in black to white. This setting information can be used for increasing contrast on a screen to thereby help the special type of user to view the screen with ease.

Further, for example, the configuration information management section 201 manages enlarged display setting information for use in setting whether or not to form a screen with enlarged screen forming elements. This setting information can be used for enlarging characters and buttons on a screen to thereby help the special type of user to view the screen with ease.

Further, for example, the configuration information management section 201 manages voice reading setting information for use in setting whether or not to enable voice reading. This setting information is used for setting whether or not to notify a user of screen information via a means other than the liquid crystal display section 110 of the console section 108, e.g. by converting the screen information to voice information.

Further, for example, the configuration information management section 201 manages voice recognition setting information for use in setting whether or not to enable voice recognition. This setting information is used for setting whether or not to use voice information as an input unit for controlling the information processing apparatus 101, in place of the input section 109 of the console section 108.

Further, for example, the configuration information management section 201 manages high contrast setting information for use in setting whether or not to increase contrast on a screen. At the same time, the configuration information management section 201 manages motion reproduction speed setting information for use in setting whether or not to reduce reproduction speed at which moving image data to be displayed on the liquid crystal display section 110 of the console section 108 is reproduced. These setting information items can be used for helping the special type of user to operate the screen with ease.

In the present embodiment, the above-mentioned setting information items for helping the special type of user, such as a disabled person, to operate the information processing apparatus 101 with ease will be generically referred to as accessibility setting information. Whether to enable or disable an accessibility setting based on the accessibility setting information can be set by a user, as desired, via a screen displayed on the console section 108 or a screen displayed on an external apparatus. More specifically, a setting configured to reverse display colors on the liquid crystal display section 110 of the console section 108 is an example of configuration for enabling an accessibility setting, whereas a setting configured not to reverse the display colors is an example of configuration for disabling the accessibility setting.

An element information management section 202 as a software module, appearing in FIG. 2, manages information on a type of screen forming elements. For example, the element information management section 202 manages information indicative of whether the screen forming elements are of a moving image, information indicative of whether the screen forming elements are of an actually shot image, and so forth.

An element display method management section 203 as a software module, appearing in FIG. 2, manages information indicative of how to display screen forming elements.

Next, a description will be given, with reference to FIG. 3, of a screen generation process for generating a screen containing a moving image, which is executed in the information processing apparatus 101. A program for implementing the present generation process is stored in one of the ROM 104, the RAM 105, and the HDD 106 as a storage unit, and is executed by the CPU 102.

The controller 103 waits (NO to a step S301) until it receives an instruction for updating a screen currently displayed on the liquid crystal display section 110 of the console section 108. Upon receipt of the instruction for updating the screen (YES to the step S301), the controller 103 starts the screen generation process and determines in the following step S302 whether an accessibility setting is enabled or disabled. In the step S301, when the input section 109 of the console section 108 having received a user operation notifies the controller 103 that the user operation has been received via the console section interface 111, the controller 103 can determine that the instruction for updating the screen has been received. Alternatively, when notified of a change in a status of the information processing apparatus 101 according to the change, the controller 103 can determine that the instruction for updating the screen has been received.

Then, the controller 103 determines whether or not an accessibility setting stored in the storage unit has been enabled (step S302). For example, the controller 103 determines whether or not reverse display of display colors on the liquid crystal display section 110 of the console section 108 has been designated (i.e. whether the reverse display is on or off). If an accessibility setting has been enabled (YES to the step S302), the controller 103 proceeds to a step S303. For example, if the reverse display of the display colors is on, the controller 103 proceeds to the step S303. If no accessibility setting has been enabled (NO to the step S302), the controller 103 proceeds to a step S306. For example, if the reverse display of the display colors is off, the controller 103 proceeds to the step S306.

In the step S303, the controller 103 determines in response to the update instruction whether or not there the screen forming elements of a screen to be generated are of a moving image. If it is determined that the screen forming elements are of a moving image (YES to the step S303), the controller 103 proceeds to a step S304, wherein how to display the screen forming elements are determined. If it is determined that there the screen forming elements are not of a moving image (NO to the step S303), the controller 103 proceeds to a step S305.

In the step S304, the controller 103 executes modification processing for reducing the speed of reproduction of the moving image contained in the screen to be generated (step S304). This modification processing is executed using the motion reproduction speed setting information managed by the configuration information management section 201. Then, the controller 103 proceeds to the step S306. Although in the step S304, the reproduction speed is reduced, any other modification processing may be performed insofar as the modification processing is for changing the accessibility. For example, the modification processing may be for increasing the reproduction speed, opposite to the above, or for increasing image contrast. Alternatively, the modification processing may be performed in which the degree of contrast enhancement is made changeable to thereby allow the user to change the strength of contrast as desired. Further, the modification processing in the step S304 may be modification processing performed on a moving image, in which a moving image is recreated by extracting and highlighting edges of the respective frames thereof. Also, the modification processing in the step S304 may be modification processing for switching the moving image to other screen forming elements than the moving image, such as replacing of the moving image by an illustration image. Further, the modification processing in the step S304 may be modification processing for switching the moving image to a white and black illustrated animation or for processing a color moving image into a white and black one. Other various types of processing can also be envisaged.

On the other hand, in the step S305, the controller 103 performs color reversal processing for reversing the display colors of the screen forming elements which are not of a moving image. This processing is executed using the RGB reversal setting information managed by the configuration information management section 201. Although in the step S305, the display colors of the screen forming elements are reversed, any other processing may be performed insofar as it is other than the modification processing performed in the step S304 on the screen forming elements of a moving image. For example, in the step S305, processing for enlarging the screen forming elements may be performed, or no processing may be performed on the same.

Then, the controller 103 generates a screen formed by the screen forming elements in the step S306, followed by terminating the present screen generation process.

The information processing apparatus 101 is capable of executing the above-described screen generation process to thereby change a method of display, depending on whether the image is a moving image or an image other than a moving image, such that the special type of user, such as a disabled person, can easily view a screen and recognize the contents of the screen with ease. As a consequence, it is possible to provide a screen that even the special type of user can easily recognize.

Next, a description will be given, with reference to FIG. 4, of a content-dependent screen generation process executed in an information processing apparatus according to a second embodiment of the present invention. As distinct from the above-described first embodiment in which the method of display is switched according to the type of screen forming elements, the second embodiment is characterized in that the method of display is switched according to a difference in contents for display, even with the same type of image forming elements.

The information processing apparatus according to the second embodiment is identical in hardware configuration to the information processing apparatus of the first embodiment. Therefore, component elements corresponding to those in the first embodiment are denoted by the same reference numerals, and description thereof is omitted. A program for implementing the content-dependent screen generation process in FIG. 4 is stored in one of the ROM 104, the RAM 105, and the HDD 106 as a storage unit, and is executed by the CPU 102.

The controller 103 waits (NO to a step S401) until it receives an instruction for updating a screen currently displayed on the liquid crystal display section 110 of the console section 108. When the controller 103 receives the instruction for screen update (YES to the step S401), the controller 103 proceeds to a step S402.

Then, the controller 103 determines whether or not an accessibility setting stored in the storage unit has been enabled (step S402). If an accessibility setting has been enabled (YES to the step S302), the controller 103 proceeds to a step S403. If it is determined that no accessibility setting has been enabled (NO to the step S402), the controller 103 proceeds to a step S408.

In the step S403, the controller 103 determines in response to the update instruction whether or not the screen forming elements of a screen to be generated are of a moving image. If it is determined that the screen forming elements are of a moving image (YES to the step S403), the controller 103 proceeds to a step S405, whereas if it is determined that the screen forming elements are not of a moving image (NO to the step S403), the controller 103 proceeds to a step S404.

In the step S404, the controller 103 performs color reversal processing for reversing the display colors of the screen forming elements which are not of a moving image. This processing is executed using the RGB reversal setting information managed by the configuration information management section 201.

In the step S405, the controller 103 determines whether or not the moving image satisfies conditions for being set as a target for changing a method of display. If the controller 103 determines that the moving image is a target for change (YES to the step S405), the controller 103 proceeds to a step S406, whereas if the controller 103 determines that the moving image is not a target for change (NO to the step S405), the controller 103 proceeds to a step S407. In the step S405, the determination is performed based on what to be reproduced as the moving image, i.e. contents of display of the moving image. For example, when the information processing apparatus 101 is in an error state and when the contents of display of the moving image are for showing a solution to the error, the controller 103 determines that the contents are a target for change, whereas when the contents of display are not for showing the solution, the controller 103 determines that the contents of display are not a target for change. Although not shown, the controller 103 performs the determination based on configuration information stored in advance in the storage unit for use in determining whether or not the contents of a moving image are a target for change.

In the step S406, the controller 103 executes modification processing for reducing the speed of reproduction of the moving image contained in the screen to be generated, and then the process proceeds to the step S408.

In the step S407, the controller 103 executes modification processing for changing the speed of reproduction of the moving image contained in the screen to be generated to a medium speed, and then the process proceeds to the step S408.

In the step S408, the controller 103 generates the screen formed by the screen forming elements.

In the information processing apparatus 101 according to the second embodiment, in the case of executing the above-described content-dependent screen generation process to generate a moving image that shows a solution to an error state, the modification processing for minimizing the reproduction speed is executed to thereby enable the user to fully understand the contents of display.

Further, in the information processing apparatus 101 according to the second embodiment, if a moving image is not for showing a solution to an error state, the contents of the moving image are less important, and hence the modification processing for changing the reproduction speed to the medium speed is executed to thereby reduce a time period required for completing the moving image. This reduces a time period over which the user occupies the information processing apparatus, thereby enabling another user to use the information processing apparatus 101 after a shorter wait time.

Although in the above-described content-dependent screen generation process executed by the information processing apparatus 101 according to the second embodiment, the processing is switched in the step S405 based on whether or not the moving image is for showing a solution to an error state, this is not limitative, but the processing may be switched based on a different criterion.

For example, the information processing apparatus 101 may switch the processing based on whether or not the moving image is for showing how to operate the information processing apparatus 101. Alternatively, the information processing apparatus 101 may switch the processing based on whether or not the moving image is for showing commercials, a corporate logo, etc., i.e. for advertisement purposes, or whether or not the moving image is one stored in advance in the storage unit.

Although in the second embodiment, the modification processing for changing the speed of reproduction of the moving image is executed in the step S406 or S407, this is not limitative, but processing different from the modification processing in the above-described example may be performed in the step S406 or S407 by a different software module. In this case, modification processing for increasing the reproduction speed or for increasing the contrast of the moving image may be executed, for example. In the latter case, the degree of contrast enhancement may be configured to be changeable so as to allow a user to change the strength of contrast.

Further, the modification processing may be processing performed on a moving image, such as modification processing for recreating a moving image by extracting and highlighting edges of the respective frames thereof. Furthermore, in the second embodiment, the steps S406 and S407 may be differentiated by executing processing for replacing a moving image with another illustration image in the step S406 and executing no processing in the step S407. When the second embodiment is thus configured, for example, it is not required to store illustration images corresponding to an entire moving image in the storage unit in advance for replacement of the moving image, which makes it possible to reduce the amount of data to be stored in the storage unit and use a remaining area for other processing.

In a case where the above-described content-dependent screen generation process is executed by the information processing apparatus 101, the method of display can be changed according to the contents of a moving image, and therefore it is possible to provide a screen that a user can easily recognize.

Although in the content-dependent screen generation process executed by the information processing apparatus 101, a screen containing a moving image is generated, a screen containing an actually shot image (an actually-shot still image or an actually-shot live image) may be generated. In this case, by differentiating the method of display between the actually shot image and the other screen forming elements than the actually shot image, it is possible to provide a screen that a user can easily recognize.

Further, although in the above-described embodiments, the information processing apparatus 101 includes the software module implementing the configuration management section 201 appearing in FIG. 2, the software module may be stored in a storage unit of an external apparatus connected to the LAN 112 via the network interface 111, thereby enabling all or some of the steps in FIGS. 3 and 4 to be executed by the external apparatus.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

### REFERENCE SIGNS LIST

101 information processing apparatus
102 CPU
108 console section
109 input section
110 liquid crystal display section

1. An information processing apparatus comprising:
a determination unit configured to determine whether or not an accessibility-related setting has been enabled; and
a generation unit configured to be operable when said determination unit determines that the accessibility-related setting has been enabled and when screen forming elements forming a screen to be displayed on a display section are of a specific type, to change a method of displaying the screen forming elements and thereby generate the screen.

2. The information processing apparatus according to claim 1, wherein when said determination unit determines that the accessibility-related setting has not been enabled, said generation unit generates the screen without changing the method of displaying the screen forming elements of the screen to be displayed on the display section.

3. The information processing apparatus according to claim 1, wherein the specific type is a moving image.

4. The information processing apparatus according to claim 3, wherein said generation unit changes a speed of reproduction of the moving image to thereby generate the screen.

5. The information processing apparatus according to claim 3, wherein said generation unit changes the moving image to an illustrated animation to thereby generate the screen.

6. The information processing apparatus according to claim 1, wherein the specific type is an actually shot image.

7. The information processing apparatus according to claim 6, wherein said generation unit generates the screen by increasing contrast of the actually shot image.

8. An information processing apparatus, comprising:
a determination unit configured to determine whether or not an accessibility-related setting has been enabled; and
a generation unit configured to be operable when said determination unit determines that the accessibility-related setting has been enabled, and when screen forming elements forming a screen to be displayed on a display section are of a specific type, and further when the screen to be displayed contains a specific type of contents for display, to change a method of displaying the screen forming elements and thereby generate the screen.

9. An information processing apparatus including a console section capable of displaying a display screen, comprising:
a setting unit configured to set whether or not to reverse display colors of the display screen; and
a control unit configured to be operable when a setting of reversing the display colors of the display screen has been set by said setting unit, to reverse the display colors of the display screen, and at the same time display a specific type of screen forming elements to be displayed on the display screen by a different display method from a display method employed in a case where the setting of reversing the display colors of the display screen has not been set by said setting unit.

10. The information processing apparatus according to claim 9, wherein the specific type is a moving image.

11. The information processing apparatus according to claim 9, wherein the specific type is an actually shot image.

12. The information processing apparatus according to claim 9, wherein the specific type is an actually shot moving image.

13. The information processing apparatus according to claim 9, wherein the different display method is a display method in which a reproduction speed is reduced.

14. The information processing apparatus according to claim 9, wherein the display of the specific type of screen forming elements is display of a solution to an error, which is performed when the information processing apparatus is in an error state.

15. A method of controlling an information processing apparatus, comprising:
determining whether or not an accessibility-related setting has been enabled; and
changing, when it is determined by said determining that the accessibility-related setting has been enabled and when screen forming elements forming a screen to be displayed on a display section are of a specific type, a method of displaying the screen forming elements and thereby generating the screen.

16. A method of controlling an information processing apparatus including a console section capable of displaying a display screen, comprising:
setting whether or not to reverse display colors of the display screen; and
reversing, when a setting of reversing the display colors of the display screen has been set by said setting, the display colors of the display screen, and at the same time displaying a specific type of screen forming elements to be displayed on the display screen by a different display method from a display method employed in a case where the setting of reversing the display colors of the display screen has not been set by said setting.

17. A non-transitory computer-readable storage medium storing a computer-executable program for causing a computer to execute a method of controlling an information processing apparatus,
wherein the method comprises:
determining whether or not an accessibility-related setting has been enabled; and
changing, when it is determined by said determining that the accessibility-related setting has been enabled and when screen forming elements forming a screen to be displayed on a display section are of a specific type, a method of displaying the screen forming elements and thereby generating the screen.

18. A non-transitory computer-readable storage medium storing a computer-executable program for causing a computer to execute a method of controlling an information processing apparatus,
wherein the method comprises:
setting whether or not to reverse display colors of the display screen; and
reversing, when a setting of reversing the display colors of the display screen has been set by said setting, the display colors of the display screen, and at the same time displaying a specific type of screen forming elements to be displayed on the display screen by a different display method from a display method employed in a case where the setting of reversing the display colors of the display screen has not been set by said setting.
